(19) United States
(12) Patent Application Publication
(10) Pub. No.: US 2012/0112430 A1
(43) Pub. Date: May 10, 2012

(54) BICYCLE TIRE TRACTION DEVICE, SYSTEM AND METHOD

(76) Inventor: JUSTIN SHAW, Bayfield, CO (US)

(21) Appl. No.: 13/290,777

(22) Filed: Nov. 7, 2011

Related U.S. Application Data
(60) Provisional application No. 61/410,900, filed on Nov. 7, 2010.

(51) Int. Cl. B62K 3/00; B23P 11/00; B60C 27/06

(52) U.S. Cl. 280/288.4; 152/221; 29/428

(57) ABSTRACT

A device for increasing traction of a bicycle is provided. The device includes two flexible tension members, each of the flexible tension members adapted to be situated on a different side of the tire, each flexible tension member including a flexible cable with first and second ends and a turnbuckle connector adapted to connect the first end and the second end of the flexible cable. The device also includes a plurality of spaced flexible connecting members coupled between the flexible tension members at a corresponding coupling point. The flexible members and the connecting members pass through the minimum interior space, when the wheel rotates and when the caliper brakes are engaged with the opposite surfaces of the rim of the bicycle wheel, without contacting the arms of the caliper brakes. A method for providing traction to a bicycle tire is provided.

### CROSS-REFERENCE TO RELATED APPLICATIONS

This application claims the benefit of U.S. Provisional Application No. 61/410,900 filed Nov. 7, 2010, which is incorporated herein by reference.

### STATEMENT REGARDING FEDERALLY SPONSORED RESEARCH OR DEVELOPMENT

Not Applicable

### BACKGROUND OF THE INVENTION

1. Field of the Invention

The present invention relates to bicycle traction. In particular, the present invention relates to a bicycle tire traction device, a bicycle traction system, and a bicycle traction method.

2. Description of Prior Art

Bicycles are used for both pleasure and work during dry and wet weather. Bicycle tires typically include an outer rubber tire tread and an inner tube. Brakes for bicycles often include calipers designed to press on both sides of the rim of the bicycle wheel. Chains may be used with car tires to improve traction in snow. However, car chain designs are not compatible with bicycle tires due to the small clearance of the caliper brakes on a bike tire. Bikes are therefore not easily used in snow.

### BRIEF SUMMARY OF THE INVENTION

A bicycle tire traction system is provided that increases bicycle traction on snow and ice. The exemplary bicycle tire traction system is removable and provides extra traction to bicycle tires. The device wraps over the tire with chain spaced evenly across the tread horizontally and is held and synched on both sides of the tire by a steel cable and attached with a swaged threaded plug and swaged turnbuckle.

A device for increasing traction of a bicycle is provided. The bicycle includes a bicycle wheel with a tire arranged on a rim, and further includes caliper brakes adapted to engage opposite surfaces of the rim of the bicycle wheel to reduce an angular speed of the bicycle wheel. The caliper brakes define a minimum interior space in a plane defined by arms of the caliper brakes when the caliper brakes are engaged with the opposite surfaces of the rim of the bicycle wheel. The device includes two flexible tension members, each of the flexible tension members adapted to be situated on a different side of the tire, each flexible tension member including a flexible cable with first and second ends and a turnbuckle connector adapted to connect the first end and the second end of the flexible cable. The device also includes a plurality of spaced flexible connecting members coupled between the flexible tension members at a corresponding coupling point. The flexible members and the connecting members pass through the minimum interior space, when the wheel rotates and when the caliper brakes are engaged with the opposite surfaces of the rim of the bicycle wheel, without contacting the arms of the caliper brakes.

When the device is mounted on the bicycle tire and the bicycle tire is inflated to a maximum pressure, the two flexible tension members and the bicycle tire may define a maximum cross-sectional area in the plane defined by the caliper brakes. The maximum cross-sectional area may not intersect an external boundary of the minimum interior space defined by the caliper brakes when engaged with the rim of the bicycle wheel.

The turnbuckle connector for each of the flexible tension members may include an externally threaded arrangement on the first end of the respective flexible tension member and an internally threaded arrangement on the second end of the respective flexible tension member.

The turnbuckle connector for each of the flexible tension members may include a turnbuckle extension including an externally threaded arrangement on a first end of the turnbuckle extension and an internally threaded arrangement on a second end of the turnbuckle extension.

Each of the flexible cables may include wire cable, and the wire cable of each of the two flexible tension members may include a plastic coating.

The plurality of flexible connecting members may include metal chains, and each flexible connecting member may be coupled to the two flexible tension members by each of the flexible cables passing through a respective one of the two terminating links in the metal chain.

The device may include a plurality of spacing arrangements on each of the flexible tension members. Each of the spacing arrangements may be positioned between adjacent coupling points. Each of the spacing arrangements may include a tubing section circumferentially enclosing a portion of the respective flexible tension member extending between adjacent coupling points. Each of the tubing sections may include plastic tubing having an outer diameter greater than an interior diameter of the terminating link in the metal chain of the flexible connecting members coupled to the flexing tension member at the adjacent coupling points.

The lengths of the flexible tension members may be substantially equal to each other and substantially equal to a circumference of a bicycle tire.

A method for providing traction to a bicycle tire is provided. The bicycle tire is arranged on a rim of a bicycle wheel, and the bicycle includes caliper brakes adapted to engage opposite surfaces of the rim of the bicycle wheel to reduce an angular speed of the bicycle wheel. The caliper brakes define a minimum interior space in a plane defined by arms of the caliper brakes when the caliper brakes are engaged with the opposite surfaces of the rim of the bicycle wheel. The method includes providing two flexible tension members, each of the flexible tension members including a flexible cable with first and second ends and a turnbuckle connector adapted to connect the first end and the second end of the flexible cable. The method also includes providing a plurality of spaced flexible connecting members coupled between the flexible tension members at a corresponding coupling point, and wrapping the two flexible tension members around the bicycle tire. Each of the flexible tension members is positioned approximately parallel to the rim. The method further includes connecting each of the turnbuckle connectors so that the flexible cables and the turnbuckle connectors pass through the minimum interior space when the wheel rotates and when the caliper brakes are engaged with the opposite surfaces of the rim of the bicycle wheel without contacting the arms of the caliper brakes.

The method may include adjusting the flexible cables to ensure that that the turnbuckle connectors are substantially perpendicular to both of the flexible cables. The connecting of each of the turnbuckle connectors may include turning each of the turnbuckles three or more times. The method may include, before connecting each of the turnbuckles by turning three or more times, attaching an extension to each of the turnbuckle connectors to extend a length of the flexible tension members.

The method may include rotating the bicycle tire and ensuring that the plurality of spaced flexible connecting members are consistently spaced and the flexible tension members sit evenly on both sides of the bicycle tire. The method may include continuing to tighten the turnbuckle connectors until the flexible tension members are securely fastened to the bicycle tire.

A device for improving traction of a bicycle is provided that includes two flexible tension members, each of the flexible tension members including a turnbuckle arrangement adapted to connect a first end of the respective flexible tension member to a second end of the respective flexible tension member to form a loop of the respective flexible tension member. The device also includes a plurality of flexible connecting members coupled to each of the flexible tension members at a coupling point.

The turnbuckle arrangements may include an externally threaded arrangement on the first end of the respective flexible tension member and an internally threaded arrangement on the second end of the respective flexible tension member.

Each of the two flexible tension members may include wire cable having a plastic coating. The plurality of flexible connecting members may include metal chains, and each of the flexible connecting members may be coupled to a respective one of the flexible tension members by the respective flexible tension member passing through a last link in the metal chain. Each of the two flexible tension members may include a plurality of tubing sections circumferentially enclosing the respective flexible tension member and extending between each coupling point of each of the plurality of flexible connecting members and the respective flexible tension member.

The device may include a plurality of spacing arrangements on each of the flexible tension members, each of the spacing arrangements positioned between coupling points of adjacent flexible connecting members. A first number of flexible tension members may equal a second number of spacing arrangements on each of the flexible tension members, and the spacing arrangements may include plastic tubing having an outer diameter greater than an interior diameter of the last link in the metal chain of the flexible tension members.

These objects and the details of the invention will be apparent from the following description and accompanying drawings.

### BRIEF DESCRIPTION OF THE DRAWINGS

FIG. 1A is a side view of a bicycle tire and a bicycle tire traction device according to an exemplary embodiment;

FIG. 1B is a front view of the bicycle tire and a bicycle tire traction device according to the exemplary embodiment shown in FIG. 1A;

FIG. 2A is a plan view of a bicycle tire traction device according to an exemplary embodiment;

FIG. 2B is a schematic view of a bicycle tire traction device according to an exemplary embodiment;

FIGS. 3A-3D are perspective partial views of a bicycle tire traction device according to an exemplary embodiment during installation on a bicycle tire;

FIG. 4 illustrates a method according to an exemplary embodiment;

FIGS. 5A-5B are cross-section views of a bicycle tire traction device according to an exemplary embodiment installed on a bicycle tire and showing caliper brakes; and

FIGS. 6A-6C are schematic views of different turnbuckle arrangements according to an exemplary embodiment.

### DETAILED DESCRIPTION OF THE INVENTION

The provided bicycle tire traction system may be used to gain traction and control while riding on ice and snow. The product consists of 2 steel cables, each with a turnbuckle on one end and a threaded plug on the other. The cables go through the open ends of the chain pieces and are then spaced evenly with tubing. The bicycle tire traction system may be used with 20 inch, 24 inch, 26 inch, or 29 inch diameter bicycle tires, and/or oversized bicycle tires. The bicycle tire traction system for one tire may include two coated steel cable connected by several short lengths of chain. Also included are two threaded turnbuckles, two swaged threaded plug assemblies, and two swaged ball plugs. The bicycle tire traction system may also utilize plastic tubing.

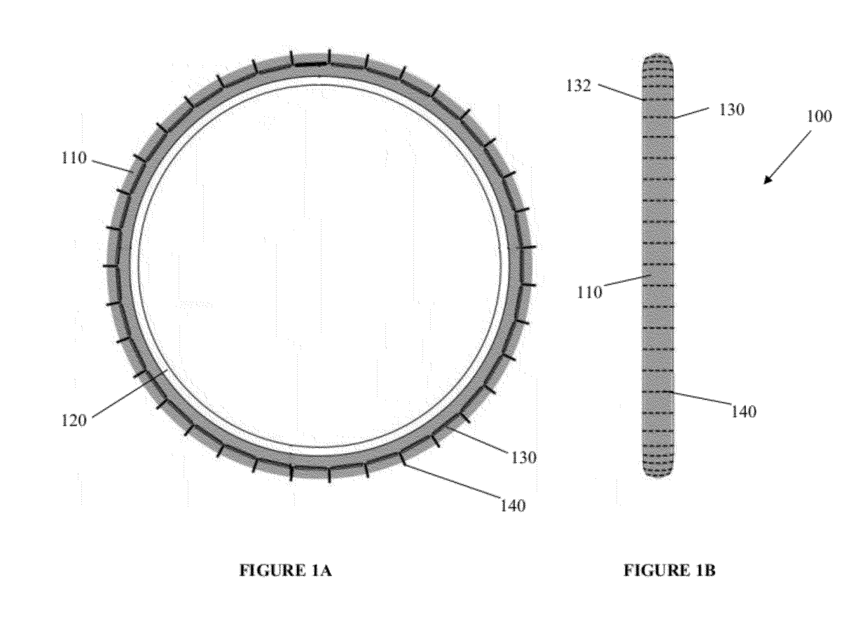

FIG. 1A is a side view of bicycle tire 110 and bicycle tire traction device 110 according to an exemplary embodiment. Bicycle tire 110 is mounted on bicycle wheel having bicycle rim 120. Bicycle tire traction device 100 includes flexible tension member 130, which may be a plastic coated wire cable or any other appropriate tension member, which runs parallel to bicycle rim 120 when installed on bicycle tire 110. Bicycle tire traction device 100 also includes several flexible connecting members 140 which connect flexible tension member 130 to another flexible tension member that is on the other side of the bicycle tire running parallel to the other bicycle rim. Flexible connecting members 140 may be metal chain or any other appropriate material that would provide traction to bicycle tire 110 when running over snow and/or ice. Flexible connecting members 140 may be evenly spaced around the entire length of flexible tension member 130.

FIG. 1B is a front view of bicycle tire 110 and bicycle tire traction device 100 according to an exemplary embodiment. Bicycle tire traction device 100 includes flexible tension members 130 and 132, which are arranged along the sidewall of bicycle tire 110 when installed on bicycle tire 110. Bicycle tire traction device 110 also includes several flexible connecting members 140 which connect flexible tension member 130 to flexible tension member 132. Flexible connecting members 140 may be evenly spaced around the entire length of flexible tension members 130 and 132, and may run perpendicular to a direction of travel of the bicycle when ridden.

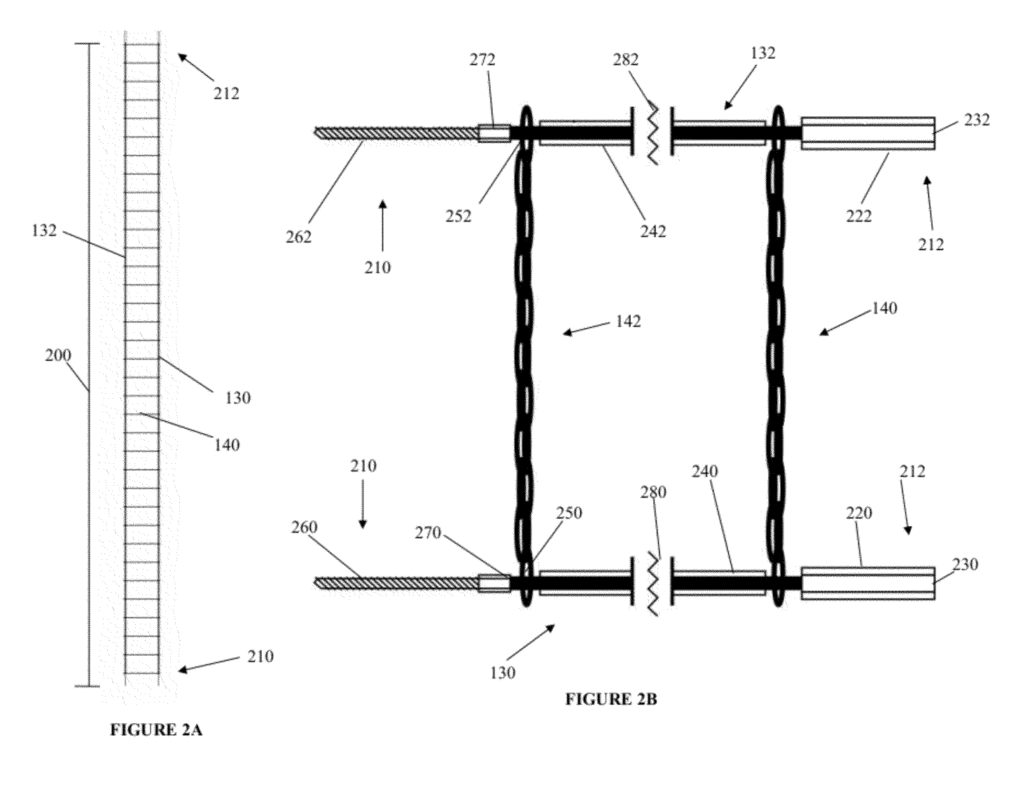

FIG. 2A is a plan view of bicycle tire traction device 100 according to an exemplary embodiment. Bicycle tire traction device 100 includes flexible tension members 130 and 132, and several flexible connecting members 140. Flexible tension members 130 and 132 have length 200, which corresponds approximately to a circumference of the bicycle tire for which bicycle tire traction device 100 may be used. Length 200 therefore may be divided by pi to obtain the diameter of the bicycle tire for which bicycle tire traction device 100 may be used. Flexible tension members 130 and 132 include on one end turnbuckle threads 210 and on an opposite end turnbuckle handles 212. The opposite arrangement of turnbuckle threads and turnbuckle handles are also possible, and it is also possible to have a turnbuckle thread and a turnbuckle handle on one end of bicycle tire traction device 100, and a turnbuckle thread and a turnbuckle handle on the opposite end of bicycle tire traction device 100 on opposite flexible tension members so that each turnbuckle thread can be mated with a turnbuckle handle.

FIG. 2B is a schematic view of bicycle tire traction device 100 according to an exemplary embodiment. Bicycle tire traction device 100 includes flexible tension members 130, 132, and several flexible connecting members 140, 142. Flexible tension members 130, 132 are shown with breaks 280, 282, respectively, which are included for illustration purposes only. Flexible tension members 130 and 132 include on one end turnbuckle handles 212. Turnbuckle handle 212 includes for flexible tension member 130 outer surface 220 and opening 230. Opening 230 is adapted to accept a turnbuckle thread into a threaded interior of turnbuckle handle 212. Turnbuckle handle 212 may include, for flexible tension member 132, outer surface 222 and opening 232. Opening 232 is adapted to accept a turnbuckle thread into a threaded interior of turnbuckle handle 212.

Flexible connecting member 142 is coupled to flexible tension member 130 by flexible tension member 130 passing through last link 250 of the chain of flexible connecting member 142. Flexible connecting member 142 is coupled to flexible tension member 132 by flexible tension member 132 passing through last link 252 of the chain of flexible connecting member 142. Alternative coupling arrangements for attaching the flexible connecting members to the flexible tension members are also possible.

Flexible connecting members 140, 142 are spaced from adjacent connecting members by plastic tubing 240, 242, respectively. In particular, plastic tubing 240, 242 may have an outer diameter greater than an inner diameter of last links 250, 252 to prevent movement of last links 250, 252 over and/or around plastic tubing 240, 242. Swage 270, 272 may couple turnbuckle threads 210 to flexible tension member 130, 132, respectively. Turnbuckle thread 210 on flexible tension member 130 may include external threads 260, and turnbuckle thread 210 on flexible tension member 132 may include external threads 262.

Turnbuckle handles 212 may freely rotate with respect to flexible tension members 130, 132 to enable a user to grasp outer surface 220, 222 and turn turnbuckle handles 212 to engage turnbuckle threads 210 on an opposite end of flexible tension members 130, 132 to connect the ends of the flexible tension members 130, 132. Alternatively, turnbuckle threads 210 may freely rotate with respect to flexible tension members 130, 132 to enable a user to grasp swages 270, 272 or a base area of turnbuckle threads 210 to engage turnbuckle handles 212 on an opposite end of flexible tension members 130, 132 to connect the ends of the flexible tension members 130, 132.

A brief description of a method of using a bicycle tire traction system according to an exemplary embodiment of the present invention may include the following steps. First, wrap Bicycle tire traction system around tire with the smooth side of the chain facing down. Then work the chains around the tire ensuring the chains are straight and evenly spaced. Second, connect the turnbuckles loosely by turning 3-4 times. Add an extension if necessary, and if so, connect loosely turning 3-4 times. Third, rotate the tire and ensure that the chains are consistently spaced and the cables sit evenly on both sides of the tire. Fourth, continue to tighten the turnbuckles until the chains are securely fastened to the tire and little or no thread is visible. Repeat the third step if necessary.

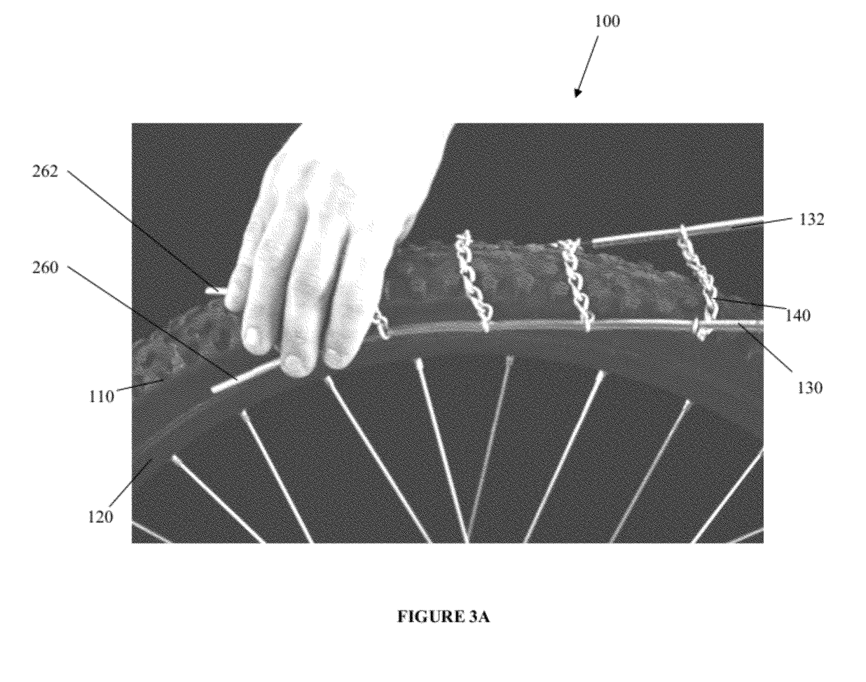

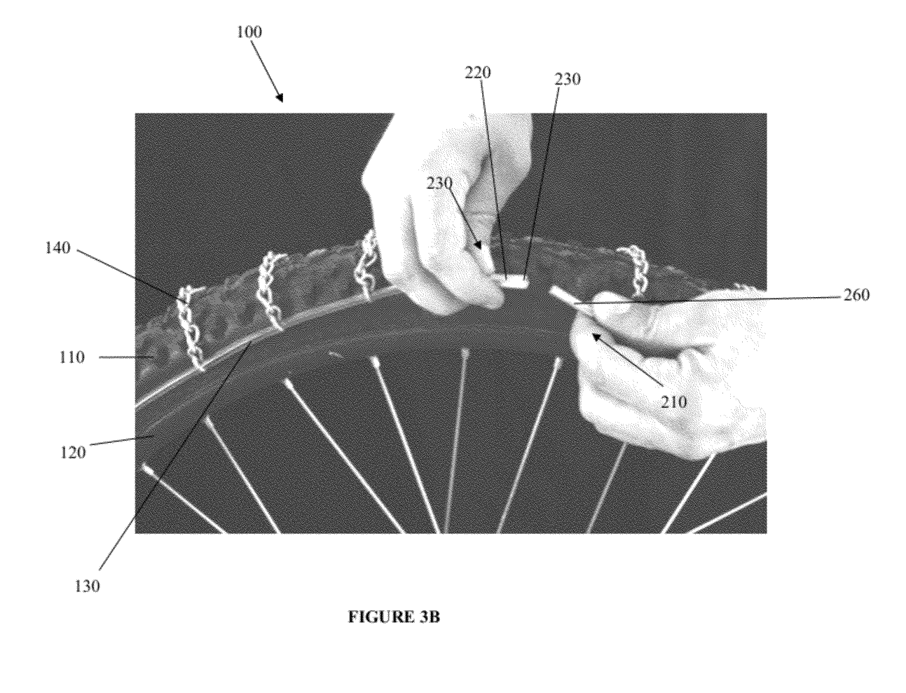

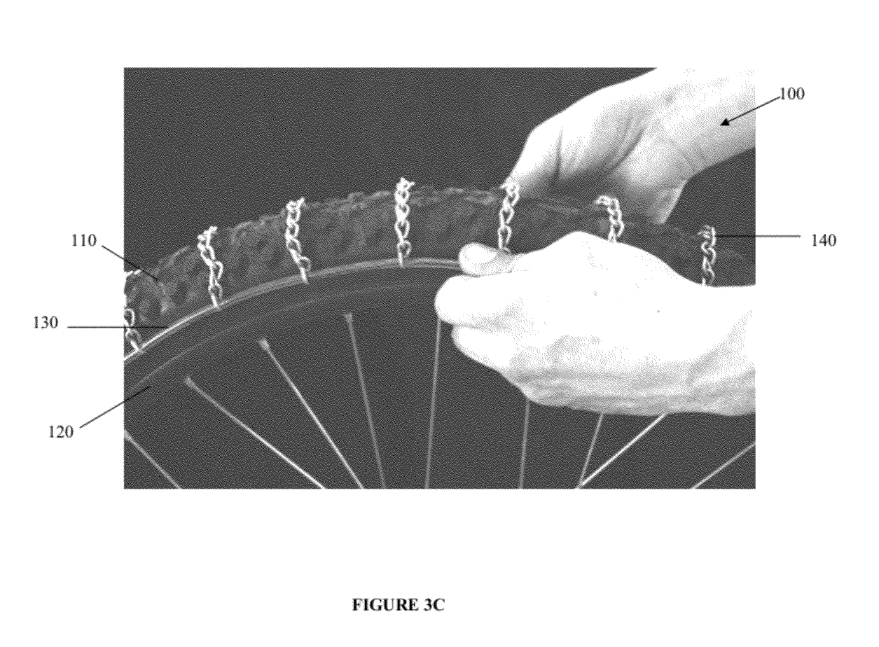

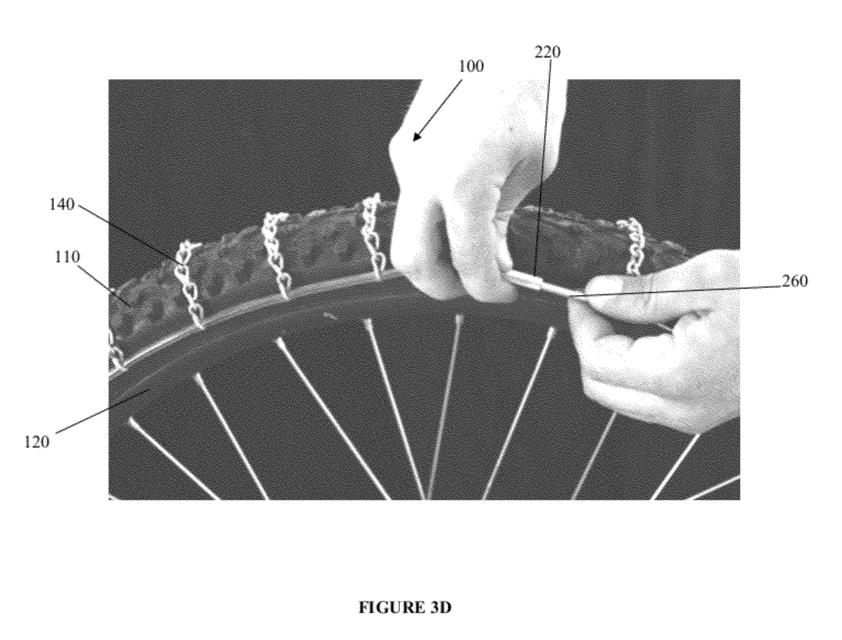

FIG. 3A is a perspective partial view of a bicycle tire traction device according to an exemplary embodiment during installation on bicycle tire 110. Bicycle tire traction device 100 includes flexible tension members 130, 132, and several flexible connecting members 140. Flexible tension member 130 is arranged parallel to rim 120, either beginning or ending with external thread 260 of a turnbuckle thread of flexible tension member 130 being approximately adjacent across the center line of the tire from external thread 262 of a turnbuckle thread of flexible tension member 132.

FIG. 3B is a perspective partial view of bicycle tire traction device 100 according to an exemplary embodiment during installation on bicycle tire 110. Turnbuckle thread 210 and turnbuckle handle 212 of flexible tension member 130 may be coupled to each other by inserting external thread 260 into opening 230 and twisting outer surface 220 of turnbuckle handle 212 by hand several times.

FIG. 3C is a perspective partial view of bicycle tire traction device 100 according to an exemplary embodiment during installation on bicycle tire 110. Bicycle tire traction device 100 includes flexible tension members 130, 132, and several flexible connecting members 140. Flexible tension member 130 is arranged parallel to rim 120, and may be adjusted along with the other flexible tension member so that flexible connecting members 140 are relatively taut and perpendicular to both flexible tension member 130 and the other flexible tension member, and so that flexible tension member 130 is the same distance from rim 120 as the other flexible tension member is from the opposite rim.

FIG. 3D is a perspective partial view of bicycle tire traction device 100 according to an exemplary embodiment during installation on bicycle tire 110. Outer surface 220 of turnbuckle handle 212 may then be twisted several more times by hand until flexible tension member 130 is tight, and the other outer surface of the turnbuckle handle on the other flexible tension member may also then be twisted several more times by hand until the other flexible tension member is tight.

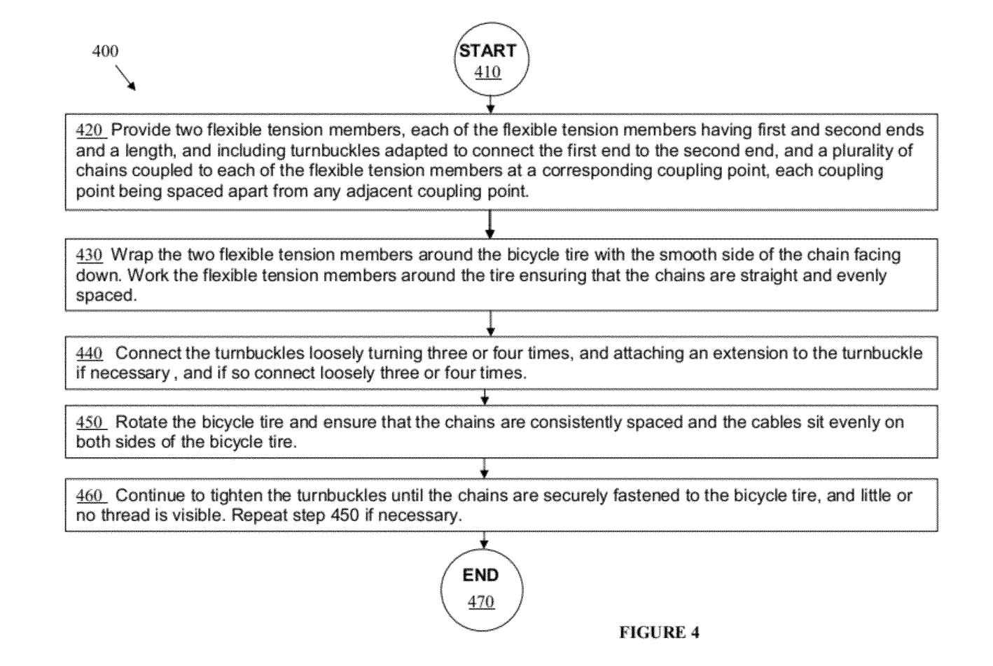

FIG. 4 illustrates method 400 according to an exemplary embodiment. Method 400 starts at start circle 410 and proceeds to operation 420, which indicates to provide two flexible tension members. Each of the flexible tension members having first and second ends and a length, and includes turnbuckles adapted to connect the first end to the second end. The flexible tension members also includes a plurality of chains coupled to each of the flexible tension members at a corresponding coupling point, and each coupling point is spaced apart from any adjacent coupling point. From operation 420, the flow in method 400 proceeds to operation 430, which indicates to wrap the two flexible tension members around the bicycle tire with the smooth side of the chain facing down, and to work the flexible tension members around the tire ensuring that the chains are straight and evenly spaced. From operation 430, the flow in method 400 proceeds to operation 440, which indicates to connect the turnbuckles loosely turning three or four times, and attaching an extension to the turnbuckle if necessary. If a turnbuckle extension is used, then connect it loosely three or four times. From operation 440, the flow in method 400 proceeds to operation 450, which indicates to rotate the bicycle tire and ensure that the chains are consistently spaced and the cables sit evenly on both sides of the bicycle tire. From operation 450, the flow in method 400 proceeds to operation 460, which indicates to continue to tighten the turnbuckles until the chains are securely fastened to the bicycle tire, and so that little or no thread is visible. Repeat step 450 if necessary. From operation 460, the flow in method 400 proceeds to end circle 470.

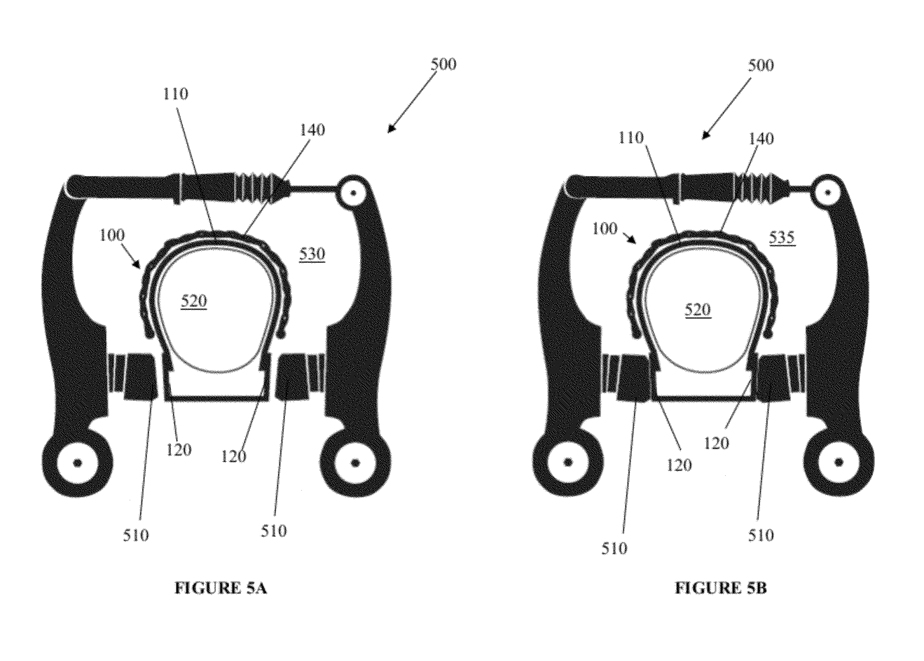

FIG. 5A is a cross-section view of bicycle tire traction device 100 according to an exemplary embodiment installed on bicycle tire 110 and showing caliper brakes 500 in a disengaged position. Bicycle tire traction device 100 includes flexible connecting member 140. Bicycle tire 110 defines an interior space 520 and is mounted on a bicycle wheel having rims 120. Caliper brakes 500 include brake pads 510 adapted to engage rims 120 to create friction and slow an angular speed of the bicycle wheel. Caliper brakes 500 define interior area 530 in a disengaged position. Bicycle tire 110 and bicycle tire traction device 100 do not intersect at any point an external boundary of interior area 530. Due to the low profile shape of turnbuckle connectors including turnbuckle threads connected to turnbuckle handles, the turnbuckle connectors also do not intersect at any point an external boundary of interior area 530. Therefore the bicycle wheel having bicycle tire traction device 100 may rotate freely without contacting caliper brakes 500.

FIG. 5B is a cross-section view of bicycle tire traction device 100 according to an exemplary embodiment installed on bicycle tire 110 and showing caliper brakes 500 in an engaged position. Bicycle tire traction device 100 includes flexible connecting member 140. Bicycle tire 110 defines an interior space 520 and is mounted on a bicycle wheel having rims 120. Caliper brakes 500 include brake pads 510 and are shown engaging rims 120 to create friction and slow an angular speed of the bicycle wheel. Caliper brakes 500 define interior area 535 in an engaged position. Bicycle tire 110 and bicycle tire traction device 100 do not intersect at any point an external boundary of interior area 535. Due to the low profile shape of turnbuckle connectors including turnbuckle threads connected to turnbuckle handles, the turnbuckle connectors also do not intersect at any point an external boundary of interior area 535. Therefore the bicycle wheel having bicycle tire traction device 100 may rotate freely without contacting caliper brakes 500.

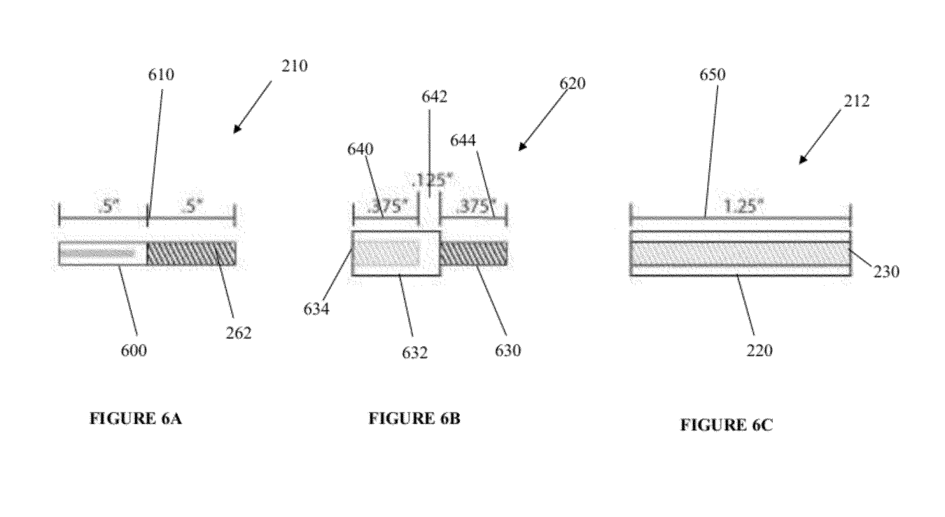

FIG. 6A is a schematic view of turnbuckle thread 210 according to an exemplary embodiment. Turnbuckle thread 210 may include external threads 262 and casing 600, which may be adapted to connect to a cable of a flexible tension member. Casing 600 may or may not freely rotate with respect to the a cable of a flexible tension member to which it is connected, and may or may not be the same as swage 270 or 272 shown in FIG. 2B couple turnbuckle threads 210 to flexible tension member 130, 132. Turnbuckle thread 210 may have length 610, which may be an inch, and which may be equally divided between the two parts of external threads 262 and casing 600.

FIG. 6B is a schematic view of turnbuckle extension element 620 according to an exemplary embodiment. Turnbuckle extension element 620 may include external threads 630 on one half and outer surface 632 on the other half. Outer surface 632 may define opening 634. Turnbuckle extension element 620 may be used to create a short extension for a flexible tension member in the situation in which the flexible tension member is too short for the tires on which it is to be used. Turnbuckle extension element 620 may have a length which is the sum of length 640 of opening 634, length 642, which is the distance between the end of opening 634 and the beginning of external threads 630, and length 634, which is the length of external threads 630. In one exemplary embodiment, length 640 may be 0.375 of an inch, length 642 may be 0.125 of an inch, and length 634 may be 0.375 of an inch.

FIG. 6C is a schematic view of turnbuckle handle 212 according to an exemplary embodiment. Turnbuckle handle 212 may include outer surface 220 and opening 230. Turnbuckle handle 212 may have length 650, which may be 1.25 of an inch.

The bicycle tire traction system may work with various brake systems, including disc and/or caliper brakes, or fenders that have ¼ inch of clearance around the tire. The provided bicycle tire traction system should be used on both tires of a bicycle. Without proper traction on the front and back, a user may lose the stability and control gained by using the bicycle tire traction system. The bicycle tire traction system may take an average of five minutes to install on both tires of a bicycle. To clean the bicycle tire traction system, place them in a mesh bag, rinse with water, and hang them to dry.

It is recommended that a rider accelerate slowly and evenly using the bicycle tire traction system, and avoid spinning the tires. The life of the chains will vary according to road conditions, driving speed and individual driving habits. Tire chains are designed only to provide extra traction in severe winter weather emergencies.

While only a limited number of preferred embodiments of the present invention have been disclosed for purposes of illustration, it is obvious that many modifications and variations could be made thereto. It is intended to cover all of those modifications and variations which fall within the scope of the present invention, as defined by the following claims.

I claim:

1. A device for increasing traction of a bicycle, the bicycle comprising a bicycle wheel with a tire arranged on a rim, the bicycle further comprising caliper brakes adapted to engage opposite surfaces of the rim of the bicycle wheel to reduce an angular speed of the bicycle wheel, the caliper brakes defining a minimum interior space in a plane defined by arms of the caliper brakes when the caliper brakes are engaged with the opposite surfaces of the rim of the bicycle wheel, the device comprising:
two flexible tension members, each of the flexible tension members adapted to be situated on a different side of the tire, each flexible tension member comprising a flexible cable with first and second ends and a turnbuckle connector adapted to connect the first end and the second end of the flexible cable; and
a plurality of spaced flexible connecting members coupled between said flexible tension members at a corresponding coupling point;
wherein said flexible members and said connecting members pass through said minimum interior space, when said wheel rotates and when the caliper brakes are engaged with the opposite surfaces of the rim of the bicycle wheel, without contacting the arms of the caliper brakes.

2. The device of claim 1, wherein, when the device is mounted on the bicycle tire and the bicycle tire is inflated to a maximum pressure, the two flexible tension members and the bicycle tire define a maximum cross-sectional area in the plane defined by the caliper brakes, the maximum cross-sectional area not intersecting an external boundary of the minimum interior space defined by the caliper brakes when engaged with the rim of the bicycle wheel.

3. The device of claim 1, wherein the turnbuckle connector for each of the flexible tension members comprises an externally threaded arrangement on the first end of the respective flexible tension member and an internally threaded arrangement on the second end of the respective flexible tension member.

4. The device of claim 1, wherein the turnbuckle connector for each of the flexible tension members comprises a turnbuckle extension comprising an externally threaded arrangement on a first end of the turnbuckle extension and an internally threaded arrangement on a second end of the turnbuckle extension.

5. The device of claim 1, wherein:
each of the flexible cables comprises wire cable; and
the wire cable of each of the two flexible tension members comprises a plastic coating.

6. The device of claim 1, wherein the plurality of flexible connecting members comprise metal chains, and each flexible connecting member is coupled to the two flexible tension members by each of the flexible cables passing through a respective one of the two terminating links in the metal chain.

7. The device of claim 6, further comprising a plurality of spacing arrangements on each of the flexible tension members, each of the spacing arrangements positioned between adjacent coupling points.

8. The device of claim 7, wherein each of the spacing arrangements comprises a tubing section circumferentially enclosing a portion of the respective flexible tension member extending between adjacent coupling points.

9. The device of claim 8, wherein each of the tubing sections comprises plastic tubing having an outer diameter greater than an interior diameter of the terminating link in the metal chain of the flexible connecting members coupled to the flexing tension member at the adjacent coupling points.

10. The device of claim 1, wherein the lengths of the flexible tension members are substantially equal to each other and substantially equal to a circumference of a bicycle tire.

11. A method for providing traction to a bicycle tire, the bicycle tire being arranged on a rim of a bicycle wheel, the bicycle comprising caliper brakes adapted to engage opposite surfaces of the rim of the bicycle wheel to reduce an angular speed of the bicycle wheel, the caliper brakes defining a minimum interior space in a plane defined by arms of the caliper brakes when the caliper brakes are engaged with the opposite surfaces of the rim of the bicycle wheel, the method comprising:
providing two flexible tension members, each of the flexible tension members comprising a flexible cable with first and second ends and a turnbuckle connector adapted to connect the first end and the second end of the flexible cable;
providing a plurality of spaced flexible connecting members coupled between said flexible tension members at a corresponding coupling point;
wrapping the two flexible tension members around the bicycle tire, each of the flexible tension members positioned approximately parallel to the rim; and
connecting each of the turnbuckle connectors so that said flexible cables and said turnbuckle connectors pass through said minimum interior space when said wheel rotates and when the caliper brakes are engaged with the opposite surfaces of the rim of the bicycle wheel without contacting the arms of the caliper brakes.

12. The method of claim 11, further comprising adjusting the flexible cables to ensure that that the turnbuckle connectors are substantially perpendicular to both of the flexible cables.

13. The method of claim 11, wherein the connecting of each of the turnbuckle connectors further comprises turning each of the turnbuckles three or more times.

14. The method of claim 13, further comprising, before connecting each of the turnbuckles by turning three or more times, attaching an extension to each of the turnbuckle connectors to extend a length of the flexible tension members.

15. The method of claim 11, further comprising rotating the bicycle tire and ensuring that the plurality of spaced flexible connecting members are consistently spaced and the flexible tension members sit evenly on both sides of the bicycle tire.

16. The method of claim 11, further comprising continuing to tighten the turnbuckle connectors until the flexible tension members are securely fastened to the bicycle tire.

17. A bicycle in combination with a device for improving traction of a bicycle tire, the bicycle comprising a bicycle wheel with a tire arranged on a rim, the bicycle further comprising caliper brakes adapted to engage opposite surfaces of the rim of the bicycle wheel to reduce an angular speed of the bicycle wheel, the caliper brakes defining a minimum interior space in a plane defined by arms of the caliper brakes when the caliper brakes are engaged with the opposite surfaces of the rim of the bicycle wheel, the bicycle and device comprising:
two flexible tension members, each of the flexible tension members including a turnbuckle arrangement adapted to connect a first end of the respective flexible tension member to a second end of the respective flexible tension member to form a loop of the respective flexible tension member; and
a plurality of flexible connecting members coupled to each of the flexible tension members at a coupling point;
wherein said flexible members and said connecting members pass through said minimum interior space, when said wheel rotates and when the caliper brakes are engaged with the opposite surfaces of the rim of the bicycle wheel, without contacting the arms of the caliper brakes.

18. The combination of claim 17, wherein the turnbuckle arrangements comprise an externally threaded arrangement on the first end of the respective flexible tension member and an internally threaded arrangement on the second end of the respective flexible tension member.

19. The combination of claim 17, wherein at least one of:
each of the two flexible tension members comprise wire cable having a plastic coating;
the plurality of flexible connecting members comprise metal chains, and each of the flexible connecting members is coupled to a respective one of the flexible tension members by the respective flexible tension member passing through a last link in the metal chain; and
each of the two flexible tension members comprise a plurality of tubing sections circumferentially enclosing the respective flexible tension member and extending between each coupling point of each of the plurality of flexible connecting members and the respective flexible tension member.

20. The combination of claim 17, further comprising a plurality of spacing arrangements on each of the flexible tension members, each of the spacing arrangements positioned between coupling points of adjacent flexible connecting members;
wherein a first number of flexible tension members equals a second number of spacing arrangements on each of the flexible tension members; and
wherein the spacing arrangements comprise plastic tubing having an outer diameter greater than an interior diameter of the last link in the metal chain of the flexible tension members.
